(19) United States
(12) Patent Application Publication
(10) Pub. No.: US 2013/0260850 A1
(43) Pub. Date: Oct. 3, 2013

(54) Mixed Reality Role Playing Games

(71) Applicants: Barry A. Carpe, Boca Raton, FL (US); Matthew J. Peterson, Ft. Lauderdale, FL (US); Jonathan A. Boyle, Boca Raton, FL (US); Stephen E. Young, Hollywood, FL (US)

(72) Inventors: Barry A. Carpe, Boca Raton, FL (US); Matthew J. Peterson, Ft. Lauderdale, FL (US); Jonathan A. Boyle, Boca Raton, FL (US); Stephen E. Young, Hollywood, FL (US)

(73) Assignee: JOGONAUT, Deerfield Beach, FL (US)

(21) Appl. No.: 13/436,283

(22) Filed: Mar. 30, 2012

(51) Int. Cl. A63F 13/00

(52) U.S. Cl. 463/9; 463/31

(57) ABSTRACT

A method of providing a game. A simulated environment is generated in which a user can play the role of a person building a personal relationship with one or more simulated individuals in the simulated environment, the simulated individual(s) representing one or more real world personalities and/or real world entities. The method includes receiving input from the user and receiving data representing real world facts related to the one or more real world personalities and/or entities. The user's progress in the game is determined based on the received user input and the received data representing the real world facts.

### FIELD

The present disclosure relates to mixed reality role playing games.

### BACKGROUND

This section provides background information related to the present disclosure which is not necessarily prior art.

Role-playing games have achieved a level of mixed reality in which a real person playing a role-playing game online may encounter a simulated situation that involves real-world characters and events. For example, in a fantasy sport game a participant may act as a team owner competing against other participants to build a team based on published statistics of real-life players of the sport.

### SUMMARY

This section provides a general summary of the disclosure, and is not a comprehensive disclosure of its full scope or all of its features.

The present disclosure, in one implementation, is directed to a method of providing a game. A simulated environment is generated in which a user can play the role of a person building a personal relationship with one or more simulated individuals in the simulated environment, the simulated individual(s) representing one or more real world personalities and/or real world entities. The method includes receiving input from the user and receiving data representing real world facts related to the one or more real world personalities and/or entities. The user's progress in the game is determined based on the received user input and the received data representing the real world facts.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a computer network for providing a game in accordance with one implementation of the disclosure;

FIG. 2 is a diagram of an architecture for logic to provide a game in accordance with one implementation of the disclosure;

FIG. 3 is a diagram of a cycle of game play in accordance with one implementation of the disclosure;

FIG. 4 is a diagram of a cycle of game play in accordance with one implementation of the disclosure;

FIG. 5 is a diagram of a game process of determining Income points in accordance with one implementation of the disclosure;

FIG. 6 is a diagram of a game process of pitching a potential client in accordance with one implementation of the disclosure;

FIG. 7 is a diagram of a game process of negotiating an endorsement in accordance with one implementation of the disclosure;

FIG. 8 is a diagram of a game process of adding staff in accordance with one implementation of the disclosure;

FIG. 9 is a diagram of a game process of determining Diva Rank in accordance with one implementation of the disclosure; and

FIG. 10 is a diagram of a game process of delivery and collection of a Performance Bonus in accordance with one implementation of the disclosure.

Corresponding reference numerals indicate corresponding parts throughout the several views of the drawings.

### DETAILED DESCRIPTION

Example embodiments will now be described more fully with reference to the accompanying drawings.

As recognized by the present inventors, participation in network-based role playing games could be highly entertaining to game participants if personal relationships between the roles played by the participants are simulated in the game environment. The present disclosure, in one aspect, is directed to a method of providing a game. A simulated environment is generated in which a user can play the role of a person building a personal relationship with one or more simulated individuals in the simulated environment, the simulated individual(s) representing one or more real world personalities and/or real world entities. Input is received from the user, and data is received that represents real world facts related to the real world personality(s) and/or entity(s). The user's progress in the game is determined based on the received user input and the received data representing the real world facts.

In various aspects of the present disclosure, a simulated environment is generated in which a game participant can play the role of a person building a personal relationship with one or more simulated individuals in the simulated environment, where the simulated individual(s) represent one or more real-world personalities and/or real-world entities. Data representing real-world facts related to a given real-world personality and/or entity may be collected and used to simulate traits for the simulated individual representing that real-world personality and/or entity. Based on input from the game participant, traits may also be simulated for the person (hereinafter “persona”) whose role is played by the game participant.

In various game versions, not only are traits simulated for the simulated individual and for the persona, but also effects of such traits on interactions simulated between the simulated individual and the persona. Based on the simulated interactions, a change in a relationship between the persona and the simulated individual can be simulated. Thus computer-generated results can be combined with offline real-world factual information to simulate the dynamics of a personal relationship between a persona and a simulated individual, including real-world events that would affect such a relationship. Opportunities can be simulated in the game environment for the persona to acquire and/or use a plurality of simulated resources to affect a relationship with a simulated individual. Simulated resources may be material, e.g., flowers may be sent by a persona to a simulated individual to please the simulated individual. Additionally or alternatively, resources may be non-material, e.g., a persona might use influence to affect a relationship with a simulated individual. A game participant's progress in the game may be determined at least in part by status of personal relationship(s) between the player's persona and simulated individuals.

Such games can take many forms. A simulated personal relationship between a persona and a simulated individual could include, e.g., a business relationship, a dating relationship, a friendship, a romantic relationship, a mercenary relationship, and/or a professional relationship, combinations of such relationships, etc. A game could provide an opportunity for a participant to play the role(s) of, e.g., an agent, a person looking for a date, a mercenary, a spy, etc. Many different game environments are contemplated in which opportunities are presented for simulating development of personal relationships with simulated individual such as, e.g., athletes and performers, well-known politicians, artists, world figures, etc. Real-world facts related to such individuals could include, e.g., news coverage, life events, dynamics of an individual's career path, publicly known personality traits, income, popularity, reputation, fame, etc. Scenarios can be simulated in which a persona and a simulated individual may interact, e.g., based on the data representing such real-world facts. An outcome of such a scenario may be provided in which a relationship between the persona and the simulated individual is changed.

In some example games, a personal relationship may be simulated between a persona and a simulated individual representing a real world entity, e.g., a team, a business, a brand, an organization, or group. In such a game, the simulated individual may exhibit simulated traits arising out of the individual's representative status. Real-world facts related to such simulated individuals would include facts related to the real-world entity. Such facts could include, e.g., news coverage of the real-world entity, reputation of the real-world entity, etc. As one example, a game participant may play the role of an agent building a personal relationship with a simulated public relations representative (“PR rep”) of a real-world corporation. The agent's goal in building the personal relationship may be to obtain the corporation (i.e., a simulation of the real world corporation) as a client. The agent may, e.g., provide an entertainment event that is seen by the simulated PR rep as being good for the corporation. The event thus may increase happiness for the simulated PR rep and accordingly for the corporation. If, e.g., the real-world corporation goes bankrupt, and if the environment receives as data a real-world news report describing the bankruptcy, the simulated PR rep may lose happiness on behalf of the corporation.

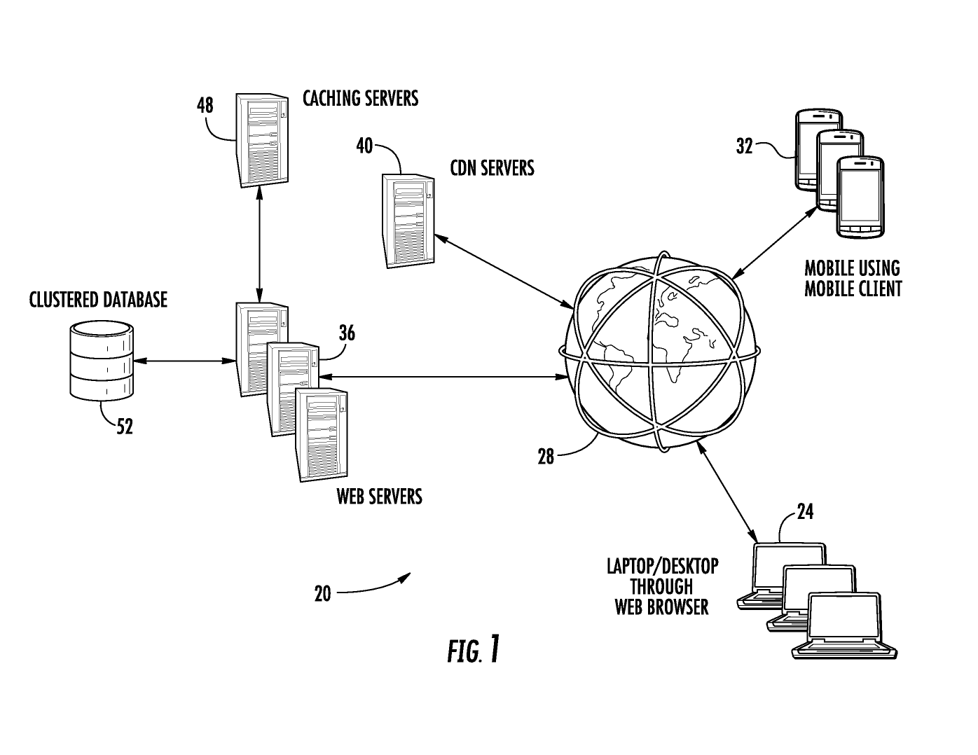

A computer network that may be used to provide a game in accordance with one implementation of the disclosure is indicated generally in FIG. 1 by reference number 20. A plurality of users may utilize computing devices 24, e.g., personal computers, tablets, etc. to access the game through a web browser and a communications network, e.g., the Internet 28. Additionally or alternatively, users may use mobile devices 32 to access the game, e.g., through a mobile client installed on the device. Web servers 36, which may be auto-scaling, are configured to receive user input and to send output of the game to the users. The servers 36 communicate via the Internet with one or more content delivery network (CDN) servers 40. The servers 40 may provide static site resources, including but not limited to images, for use in the game. One or more dedicated servers 48 are used to cache and serve commonly requested data. A clustered database 52 is used to handle the distribution of read requests to the web servers 36. It should be noted that other or additional ways are possible for users to access the game. A network could be configured in various ways, and with various numbers and types of servers, databases, browser alternatives, and user interfaces other than or in addition to the way in which the network 20 is configured.

In one example embodiment of a game, a simulated environment is generated in which a user can play the role of an agent for one or more real world individuals such as an athlete, a performer, a politician, and/or an artist. Input is received from the user, and data is received that represents real world facts related to the real world individual(s). The user's progress in the game is determined based on the received user input and the received data representing the real world facts. Opportunities may be simulated for the agent to acquire and/or use a plurality of resources to develop an agent career. Such resources can include but are not necessarily limited to experience, income, and/or influence. Opportunities may also be simulated for the agent to add infrastructure and/or staff, e.g., in order to be able to manage additional clients. Scenarios may be simulated in which traits of the agent and the real world facts related to the real world individual(s) influence an outcome of interaction between the agent and the real world individual(s). Opportunities may be simulated in the environment for the agent to make and/or keep the real world individual(s) happy as client(s) of the agent. The agent may, e.g., make telephone calls, give gifts, fulfill requests, make deals, exert influence, make a pitch, entertain, and network for a client.

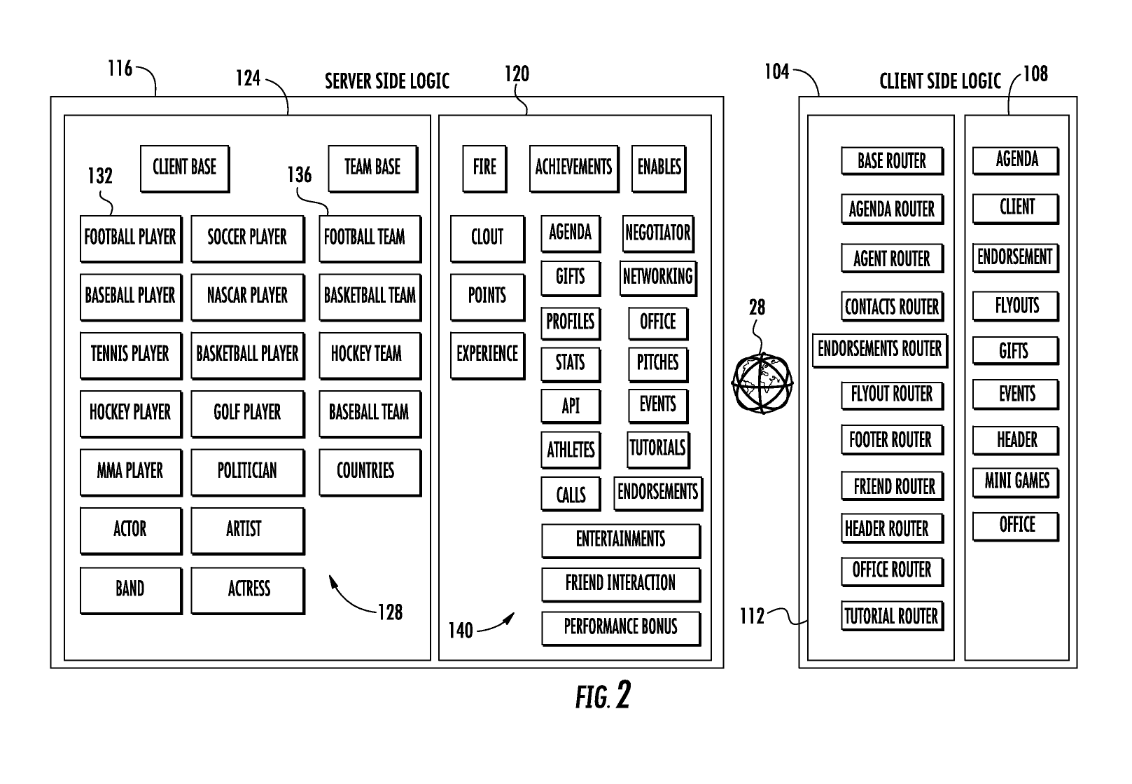

An example architecture for logic to provide a game in which a user can play the role of an agent is indicated generally in FIG. 2 by reference number 100. Client-side logic 104 includes interface logic 108 for handling user calls to a user device web interface, e.g., a browser or application loaded on or available to the user device. Interface logic 108 also processes responses received by the user device. Router logic 112 routes user calls to appropriate pages and/or game flows, which are handled by server-side logic 116. A web interface layer 120 runs business logic to process user requests and makes calls into a model layer 124. The model layer 124 includes a plurality of accesses one or more databases for maintaining current real-world data relating to real-world individuals. The model layer 124 includes a plurality of models 128, e.g., classes, describing personal and other characteristics of various types of individuals, e.g., athletes, artists, etc. who are or might become clients of a user's game persona. Individual types are modeled in classes 132. Classes 136 also are included that describe characteristics of types of groupings of individuals, e.g., sports teams, countries, etc. The model layer 124 may process the current real-world data relating to real-world individuals in relation to a given model 128 and return results to the web interface layer 120. The web interface layer 120 may return the results to the user and/or use the results and various logic blocks 140 to make decisions relating to actions in the game. It should be noted that the modeling combined with real-world data may be used in accordance with various algorithms to simulate relationship dynamics between the user's persona and a real-world individual as further described below.

In one example implementation, a single user or more than one user can participate in a game in which a user plays the role of an agent. For the present game, real-life information about a real-life person is entered into a database. The real-life information is used to simulate the real-life person and to configure game tasks and rewards or tribulations for the game player, who tries to obtain and keep the simulated real-life person as a client. This information can include, e.g., the real-life person's salary as well as notoriety, including his involvement with charitable organizations and/or criminal activity. Such characteristics can be used to evaluate “likability of the character.” Data describing real-world performance by the real-life person also may be used, e.g., to provide performance bonus points to a game player. By considering multiple aspects of a potential or actual client's real-life, including those that go beyond professional performance, the game provides increased realism for the game player.

The present disclosure, in various aspects, is directed to simulating a realistic experience of an actual career, e.g., managing human talent, whether as a sports agent, literary agent, acting agent or other talent agent. Sub-games and tasks are provided in the game to simulate the tasks of such an agent, including prospecting, managing the careers of clients, maintaining clients' happiness and identifying and nurturing young talents to become stars. An online participant playing the role of an agent aims to contact, pitch, and contract with a potential client to represent him or her. This potential client is a virtual representation of a real-world figure who could be an athlete, celebrity, politician or other sought-after person.

In order to pitch, sign and keep clients, the agent engages in PEN (Pitch, Entertain and Network) activities. These activities are simulations of real-world scenarios that include actions typically taken by a talent agent to increase the value of his clients and increase the agent's earnings and influence. Simulation of actually working as an agent is further demonstrated with management tasks including negotiating endorsements, cold calling on potential prospects, and using telephone calls to stay in touch with current clients. An experience of realism within the game can be enhanced by the use of resources such as Experience (time), Income Points (money) and Clout (influence). Instead of basing success in the game solely on time and money, Influence is required for the agent persona to achieve certain tasks or obtain certain items and can provide the ability to complete tasks that would normally take many years of experience. For example, in the real world, access to a rare object may require more than money. It may be “who you know.” And in the real world, “who you know” might result in a phone call that might otherwise take years of experience or a large amount of money. The game also simulates real life by incorporating multiple traits of a real-world person, then applying an algorithm to simulate the difficulty of managing that person.

As in many Massively Multiplayer Online Reality Role-Playing Games (MMORRPGs), a player of the present game is represented by an artificial character (persona.) The player may choose to conceal his real identity or may choose to reveal it, e.g., by sharing the game via Facebook® or other social networking venues. The player selects a persona at game onset. Traits of the selected persona can have consequences in scenarios of the game.

A player may access the game, e.g., via a web browser with a Facebook login, via IPhone®, or Android™ smart phone. The persona, as controlled by the player, then works to pitch and sign new talent while keeping his current clients happy. The agent persona may use a variety of methods including keeping in contact through telephone calls, sending gifts, and fulfilling requests (referred to as Agendas/Messages) from a client. The agent persona also tries to increase his income and client Happiness by negotiating endorsement deals for the client. In order to succeed in the game, agent personae depend on Income Points, Clout, Endorsement Deals, and Years of Experience. It should be noted generally that although various names (e.g., Clout, PEN, etc.) may be used herein to identify various game concepts and/or elements, such names are not the only ones that could be used to identify such concepts and/or elements.

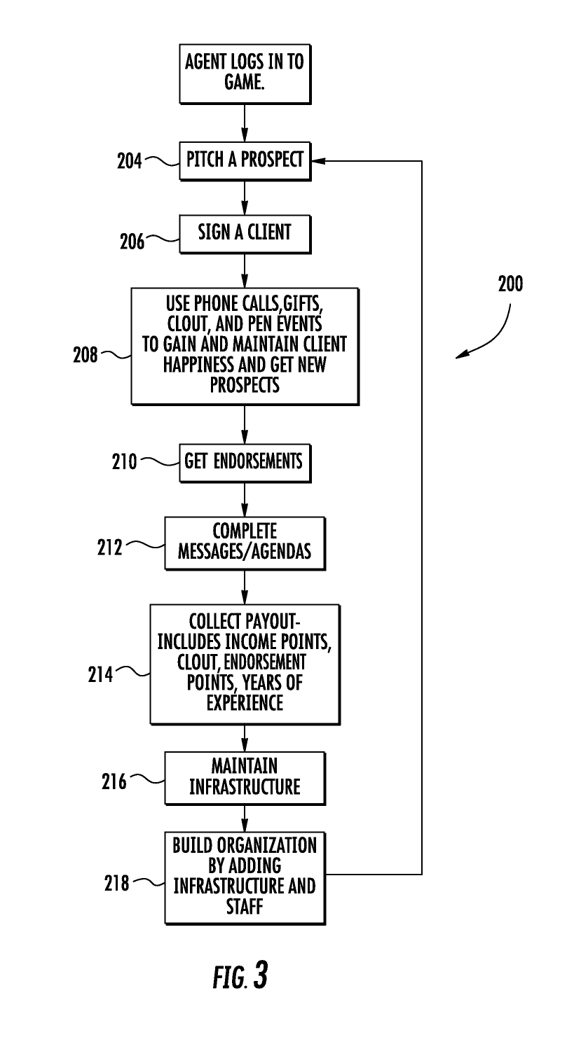

A flow diagram of an example cycle of game play is indicated generally in FIG. 3 by reference number 200. It should be noted that the cycle 200 is simplified, and game flow is not necessarily linear as shown in FIG. 3. In process 204 an agent persona (“agent”) pitches a prospect. In process 206 the agent signs a client. In process 208 the agent uses telephone calls, gifts, Clout, and PEN events to gain and maintain the client's Happiness and to obtain new prospects. In process 210 the agent gets endorsements for the client. In process 212 the agent completes Messages/Agendas for the client. In process 214 the agent collects his Payout which includes Income Points, Clout, Endorsement Points and Years of Experience. In process 216 the agent maintains the infrastructure of his organization. In process 218 the agent adds infrastructure and staff in order to be able to manage additional talent. The cycle 200 then may begin anew.

Income Points represent the agent's income based on economies within the game. Economies can include salary based on client income; signing bonuses when new talent is recruited and signed; performance bonuses based on clients' performance; and income collected after successfully completing an endorsement deal. Income Points also may be gained through online time played, and by winning sub games played during the session.

Clout represents an agent's influence. Clout is a fluctuating system of influence that can open new avenues of game-play when it is high. Clout may be used up by an agent persona to perform various in-game actions. Agent personae may gain Clout in various ways, e.g., by keeping clients happy; by adding infrastructure, hiring staff and purchasing additional locations to increase the capacity of the agent's organization; by completing PEN (Pitch, Entertain, and Network) events and by completing Messages/Agendas as further described below. Clout also may be gained through online time played, and by winning sub games played during the session.

Fire is an ultimate form of Clout. When Clout points are received during the game based on actions taken, Fire points are also received. As Fire points are received, a Fire Gauge is filled. Once full, the player's agent persona is considered “On Fire.” This is a short-lived time where a player can accomplish more than when the agent persona is not On Fire.” Certain items and tasks can only be completed while On Fire, and a pitch is more likely to be successful while On Fire.

Endorsement deals can result in additional Income for an agent persona. Endorsement deals may be required by clients in order to maintain clients' Happiness. Endorsement deals add to an experience of realism in the game by simulating a task that real world talent agents are required to complete. Endorsement deals are negotiated by having the correct amount of Endorsement points to allow a negotiation, then successfully playing two online games. A first game simulates negotiating the amount of the endorsement, and a second game simulates negotiating the duration of the endorsement. If the two Endorsement games are successfully played, an endorsement is granted to the client based on the agent persona's negotiating.

An agent persona must gain experience in the game to successfully complete an Endorsement. Experience may be gained by completing game actions such as Messages/Agendas. Once the required experience is gained, the Endorsement is put into a collect state. The player may then log into the game and collect his Income Points gained from the Endorsement. As with collecting other forms of Income in the game, the player must visit the game and affirmatively collect those points.

Years of Experience may be determined based on a linear value determined, e.g., by time playing the game. Years of Experience represent day-to-day experience gained by working, plus experience gained by actions taken in the game.

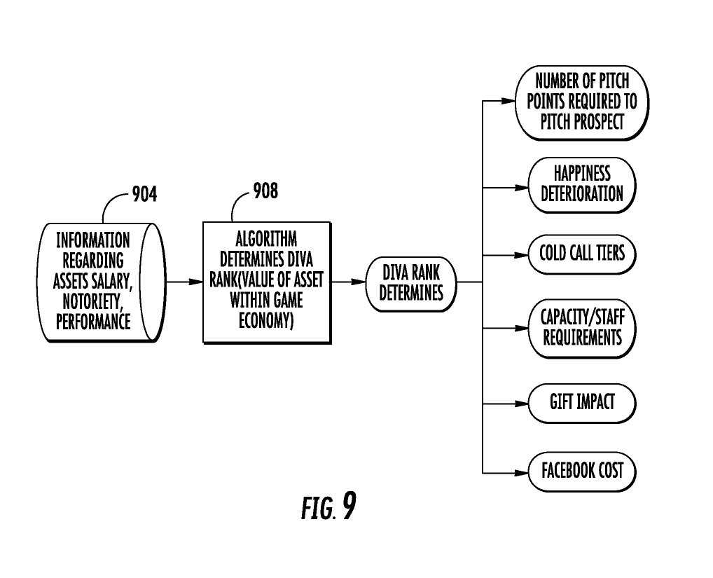

In order to more effectively simulate the experience of a real world agent, each prospect/client in the game is given a Diva Rank, as shown in FIG. 9. Real-life data, represented by Notoriety, Income/Salary and Performance Bonuses 904 of the real-life celebrity, are used in an algorithm 908 to obtain a Diva Rank for the simulated celebrity. In such manner a ranking can be derived that represents the difficulty, if any, to obtain, represent, and/or maintain a virtual relationship with that simulated celebrity. For example, a Super Bowl winning quarterback would be likely to have a higher Diva Rank than a first-year rookie, and an Academy Award winning actor would be likely to have a higher Diva Rank than a contestant on a reality television series. Additionally, a Diva Rank for a simulated celebrity could be raised or lowered, e.g., in substantially real time, in response to real-world events described in the real-life data 904. For example, if a simulated celebrity represents a real-world celebrity who becomes involved in a publicized crime, the Diva Rank for the simulated celebrity may be lowered. A simulated celebrity who has a high Diva Rank could pose difficulties to an agent persona. For example, it could be harder to obtain that simulated celebrity as a prospect. More pitch points and capacity to pitch would be needed to obtain that simulated celebrity as a prospect. It also could be more difficult to actually sign that simulated celebrity as a client, who could then require higher level items to obtain Happiness, which could deteriorate faster than would the Happiness of a simulated celebrity with a lower Diva Rank. A simulated celebrity who has a high Diva Rank may require specific endorsements and staff members, and may require higher-level entertainment events in order for an agent persona to keep developing the relationship.

It should be noted that in various games in which real world entities are simulated, a simulated entity may have a Diva Rank. Such ranking may be based, e.g., on prestige and other real-life data. Thus a simulated individual who represents an entity having a high Diva Rank may be more difficult to keep happy on behalf of his/her entity than would be the case if the entity had a lower Diva Rank.

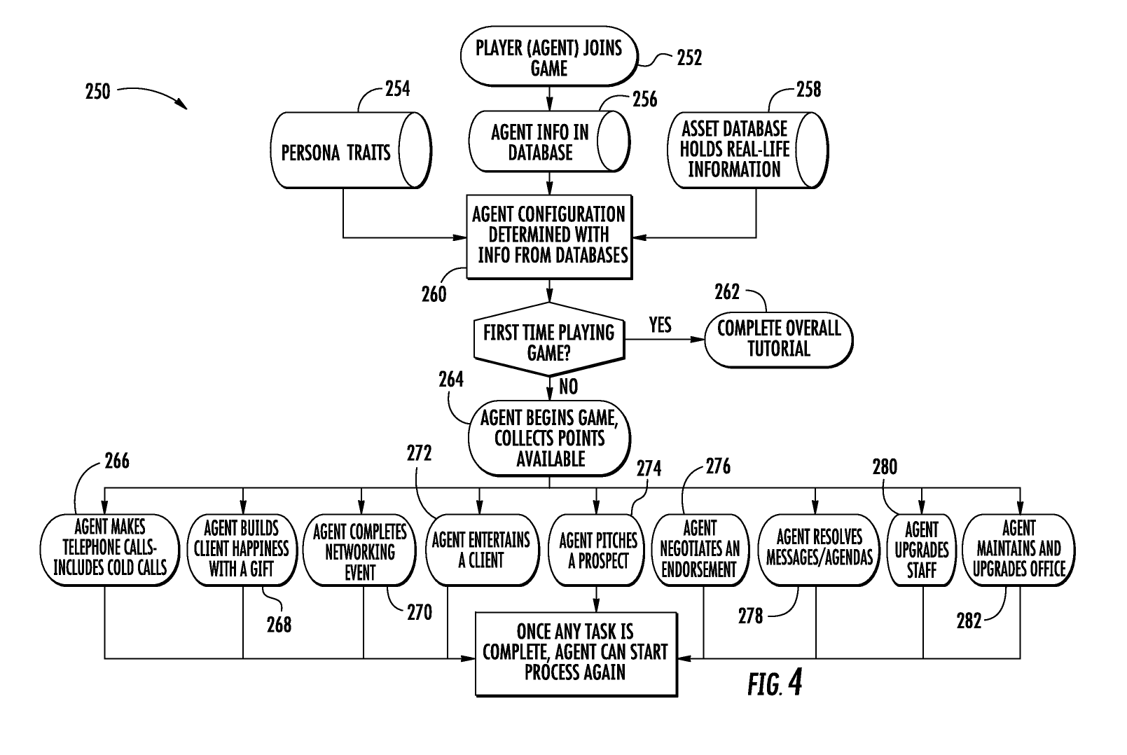

A flow diagram of another example of game play flow is indicated generally in FIG. 4 by reference number 250. To start the game, a player must register in a process 252. Upon registering for the game, the player selects a character (persona) to play and a location for his persona's initial office. This information is stored in a database 256. Based on the traits of the persona selected and the selected initial office location, in a process 260 the player is given a number of initial clients and prospects. This is configured using persona traits from a database 254 that correspond to the player's selected persona and information from a database 258 describing real world persons (e.g., clients and/or prospects). The first time a player begins the game, in process 262 he may access an interactive tutorial describing the steps for playing and succeeding in the game. An overlay tutorial may also be available to provide help to a player.

The player may begin the game in process 264. Once the player begins the game, several possible scenarios are available to the player, e.g., in an online session. The agent collects income to receive points. Depending on how long the player has been offline, the income may be at a maximum amount. If a Performance Bonus is available, the agent may collect this. If it is the agent's first login of the day, he collects his daily bonus.

In process 266 the agent may make phone calls to clients and/or prospects to simulate checking in with clients and preparing to pitch a prospect. Based on the results of the calls, the player may receive or lose Clout or Happiness. He may also gain a new prospect. Optionally, the agent may Cold Call a person he would like to have as a prospect. In this case, if he succeeds on the call and that person becomes a prospect he may begin a pitch to that prospect. A series of questions may be presented that must be answered, simulating a conversation. Depending on the answers given, the agent may succeed or fail in getting the person as a prospect. The tier of questions asked and appropriate answers are in-part determined by the potential prospect's Diva Rank.

In process 278 the agent checks Messages/Agendas to view the requests from his clients and to determine which requests he can fill. The ability to fulfill requests is determined by Clout, Points Available, Years of Experience and sometimes Fire. As each Message/Agenda is completed, the agent receives benefits that may include Clout, Fire, additional experience, and Endorsement points. The amount of these is determined by the difficulty and expense of the task completed.

In order to keep his clients happy and gain new clients, the agent must engage in PEN (Pitch in process 274, Entertain in process 272, and Network in process 270) activities. Clout is required in order to access many of these activities. The agent may select activities to complete based on Clout required for an activity, cost of an activity in Income Points, and/or time required for the activity. Time can become important because in order to collect a payout for an event, the player must login and manually collect the payout within a specific time after the completion of the task.

In process 268 the agent may send a gift to a client or prospect in order to gain Happiness for the client or prospect. Happiness levels of clients are a key part of determining the amount of Income Points an agent receives and Happiness levels of prospects help determine the success in signing the prospect as a client after a pitch.

In process 276 the agent may try to negotiate an endorsement for one of his clients. If he is successful, he will be able to collect his income from this endorsement after the defined amount of time has passed. If an Endorsement has been completed, the agent returns to a game display for the Endorsement to collect his Income Points earned by the Endorsement.

If necessary, the agent may spend Income Points in process 282 to maintain his infrastructure. The physical infrastructure of the buildings must be maintained throughout the game in order to maintain maximum Capacity. This is done with Income Points. Since Capacity is needed in order to attract, pitch and sign clients of increased value, the agent may add office infrastructure and the staff in process 280 to support such infrastructure.

The above scenarios can be repeated over time and agents are rewarded for visiting the site often, gathering their income, completing Messages/Agendas and playing sub-games while engaging in PEN events.

Some limitations may apply to the purchase of certain items. Items that require Fire may only be purchased while the player's persona is on Fire and some items are only available for purchase based on Years of Experience. Additionally, certain items must be purchased with Clout instead of Points. In some embodiments, a player may purchase certain items by using Facebook credits and/or other credits that may available through social networks and/or as part of a “customer rewards” program, and/or earned by completing tasks online. Items that may be purchased using such credits may include clients, gifts for clients, entertainment events, pitch events, staff and office upgrades. In some embodiments, certain items such as specialty events and additional locations may only be available using these credits and may not be available in exchange for points or Clout.

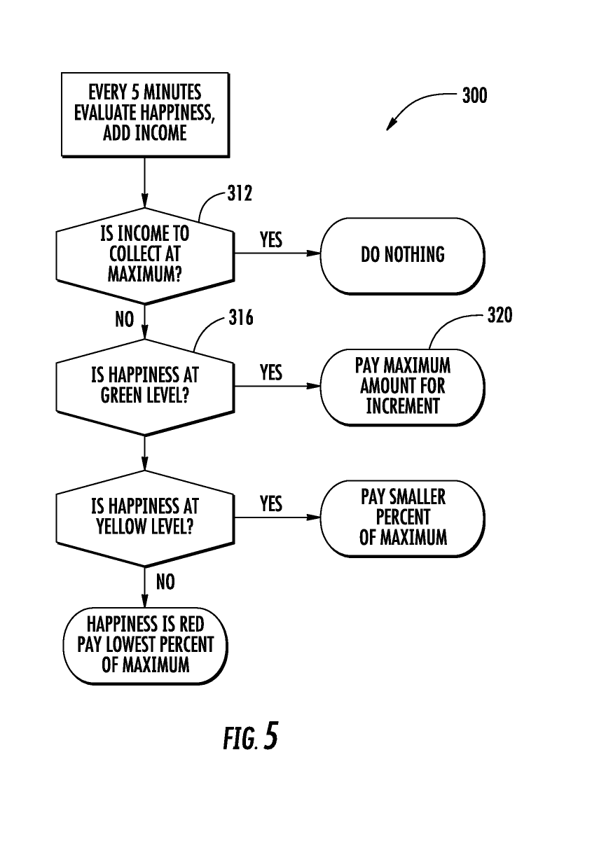

As discussed with reference to process 264 (shown in FIG. 4,) a player may collect his Income points from his Client Income Bonus. A Client Income Bonus may be determined as shown in a process indicated generally in FIG. 5 by reference number 300. Every five minutes, it is possible for the player to receive part of his Client Income Bonus based on client salary and Happiness. He must collect this bonus manually, in order to receive the points, and once his Income Meter reaches the maximum no more will be added until he collects. The Maximum possible income is calculated based on the aggregate of all of the agent's clients' real world salaries as adapted to the game economy. If in process 312 his Income Meter is not at maximum, then the level of Happiness of his clients is determined. If in process 316 his clients' Happiness is at the Green level, the maximum increment is paid in process 320. If the Happiness level is Yellow or Red, a lesser increment is paid.

After collecting his Client Income Bonus, the player may collect his Performance Bonus, if one is available. The Client Performance Bonus is a system for calculating a bonus based on the real world performance of the agent's clients. Performance metrics for the game may include but are not limited to the following: number of team or individual wins; number of home runs; number of runs batted in; All-Star Selection; Most Valuable Player Award; Cy Young Award; a Grammy Award; a Golden Globe Award; an Emmy Award; a new Movie Release; a Box Office Hit; a Platinum Record; a Senate Nomination; a Senate Win; a Drug Possession Charge; a Sexual Assault Charge; a Moving Violation; a Divorce; an Embarrassing Photo; etc.

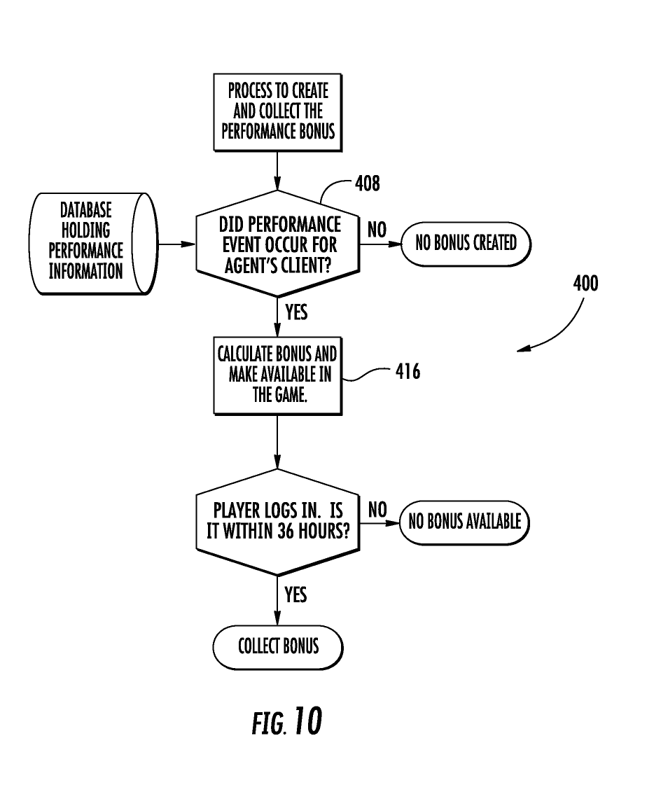

Game processes and agent steps to collect a performance bonus are indicated generally in FIG. 10 by reference number 400. As real world events are gathered into a database, they are evaluated against the agent's client list. If in process 408 it is determined that the agent has a client that is simulated to represent a real person who engaged in a real-world performance event, a Performance Bonus is calculated and becomes available in process 416, e.g., on a main display screen of the game. A Performance Bonus may be available, for example, for only thirty-six hours after the real-world event takes place. This motivates the agent to stay involved with the game and access it frequently so not to lose a bonus. After collecting available bonuses, the player continues with the game selecting any of several possible common scenarios.

An agent checks his Messages/Agendas and resolves these Messages/Agendas in order to receive Clout, Fire, Years of Experience, Gifts, Endorsement points and/or client Happiness. Several systems may be used to determine the Messages/Agendas that are delivered to the agent from the clients. A system of categorization may assign a Message/Agenda difficulty to underlying Messages/Agendas templates based on the category, type, and brand of each message/agenda resolution. Another system is an algorithm that calculates the agent's ability to resolve a message/agenda. Yet another system is a method of delivery that considers the agent's ability, the Messages/Agendas difficulty, the client's capacity, and a random chance to ignore some or all of these factors. Additionally or alternatively, in a data-driven system, Messages/Agenda may be created and delivered depending on various data points mined from the user's activity. In a consecutive system, Messages/Agendas are delivered linearly in a pre-determined sequence.

For the messages/agendas difficulty system, every retention category, type, and brand may be pre-assigned a difficulty value based on an algorithm that considers the point costs and level gates associated with its respective gifts. To calculate the message/agenda difficulty, every message/agenda resolution is examined with respect to its gift's category, type, and brand difficulty values. The message/agenda difficulty is equal to the single highest difficulty value from these message/agenda resolutions.

For the agent ability system, agent ability is calculated using an algorithm that considers the agent's current unspent points and current days of experience.

For the message/agenda delivery system, every message/agenda template is organized into a single set. Then, the client's minimum difficulty threshold is calculated from the client's capacity. A percentage of message/agenda with a difficulty that falls below the client's minimum capacity threshold are removed from the set. A weighted random chance determines whether the delivery system should include additional filtering of the set, or if the system should skip this filtering phase. An algorithm combines the agent's ability and the client's Diva Rank to determine a maximum difficulty threshold. All messages/agendas that have a difficulty higher than the maximum difficulty threshold are removed from the set. After the filtering phase is complete, the set is shuffled and a message/agenda is generated for the client. This system may be repeated periodically, e.g., every fifteen minutes, until the agent has accumulated a predetermined maximum number of messages/agendas.

A player's persona engages in pitching a prospect with the goal of signing a new client. The ability to pitch a prospect may be based on capacity and pitch points. Pitch points represent the affinity a targeted prospect may have for an agent's agency. A targeted prospect having a high Diva Rank, for example, may have minimum requirements that are higher than those of a prospect that has a lower Diva Rank. Pitch points can represent a range of minimum requirements. The concept of capacity is based on the fact that higher-value potential clients will require more time and energy than others. Capacity is based on the agent's ability to support that prospect. Such ability is gauged by the agent's Clout, the agent's having office and staff near the potential client, and the agent's Years of Experience.

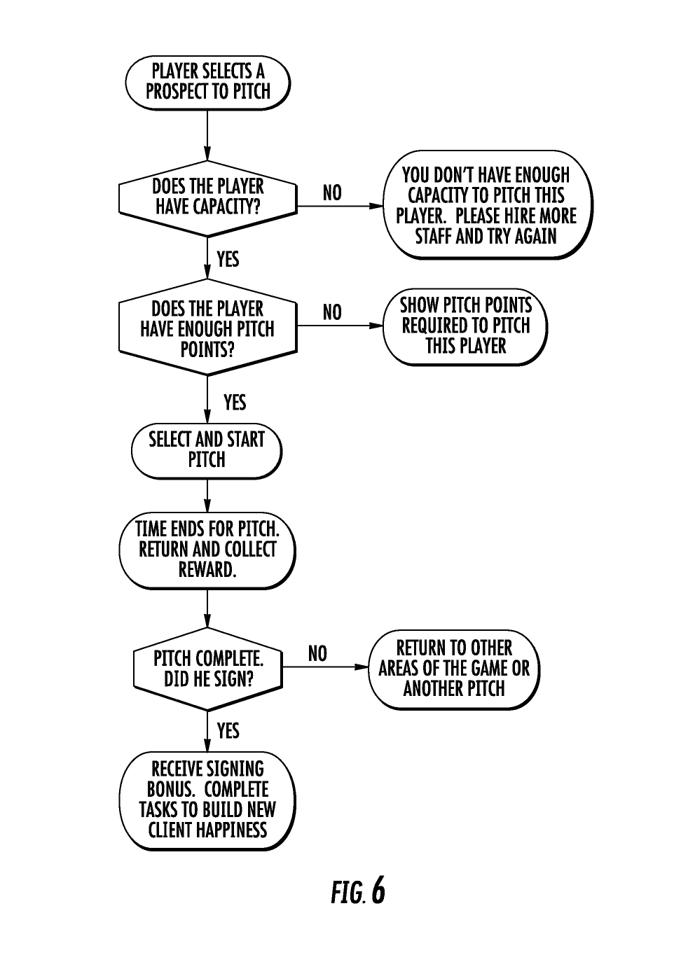

As shown in FIG. 6, in order to complete the pitching process, the agent selects a prospect and a specific type of pitch. Pitch types vary in length and value. Longer pitch types are of more value, cost more points, require more Clout and may require being on Fire. Once the time of the pitch is complete, the player must manually collect his pitch outcome. As mentioned previously, for each type of PEN event, a player must return to the game and manually click on that task to collect the rewards.

When he collects his pitch reward, the player is alerted to whether the agent signed that prospect as a client. If he successfully signed the prospect as a client, he receives a signing bonus. The success of signing a prospect is determined by the prospect's Happiness and length/value of the pitch. Higher Diva-Ranked prospects require higher valued pitches.

Entertainment activities allow an agent to entertain clients. These lead to increased prospects and may reward the player with Clout, Fire, Endorsement points and/or Years of Experience. Entertainment activities are also important in maintaining client Happiness as they signify the effort made to create and foster a long-term relationship with the client. Like Entertainment activities, Networking activities may reward the player with Endorsement points and/or Contracts with companies. Networking activities simulate those from the real world including Email, Social Networking and Conference Calls. Only one of each type of PEN activity can be completed at a time. The player must affirmatively return to the game in order to collect the reward from the activity.

Many of the possible game scenarios are designed to improve and maintain the Happiness of the agent's clients. Much of the agent's income is based on keeping clients happy as is the ability to get, pitch and sign new prospects, so keeping clients happy is a main goal in the game. The game includes a method to determine the Happiness of represented assets (i.e., clients) and a method that derives payment amounts based on this Happiness factor. Actions within the game that improve and maintain Happiness include resolving Agendas, sending gifts and making telephone calls to clients and prospects, entertainment events, and pitching.

A gifting system allows an agent to buy, store and give one of his clients a virtual item in a digital game environment for the purpose of advancing their position in the game. Purchasing gifts may cost the player Clout and/or Income Points when the agent acquires the virtual item and will earn Happiness for a client when the agent gives the client the virtual item. The amount of Happiness earned for a particular gift depends on the client's Diva Rank and the value of the gift. Endorsement points are also rewarded when gifts are given. These correspond with the value and industry of the gift. For example, a gift of a professional camera will result in Electronics Endorsement Points.

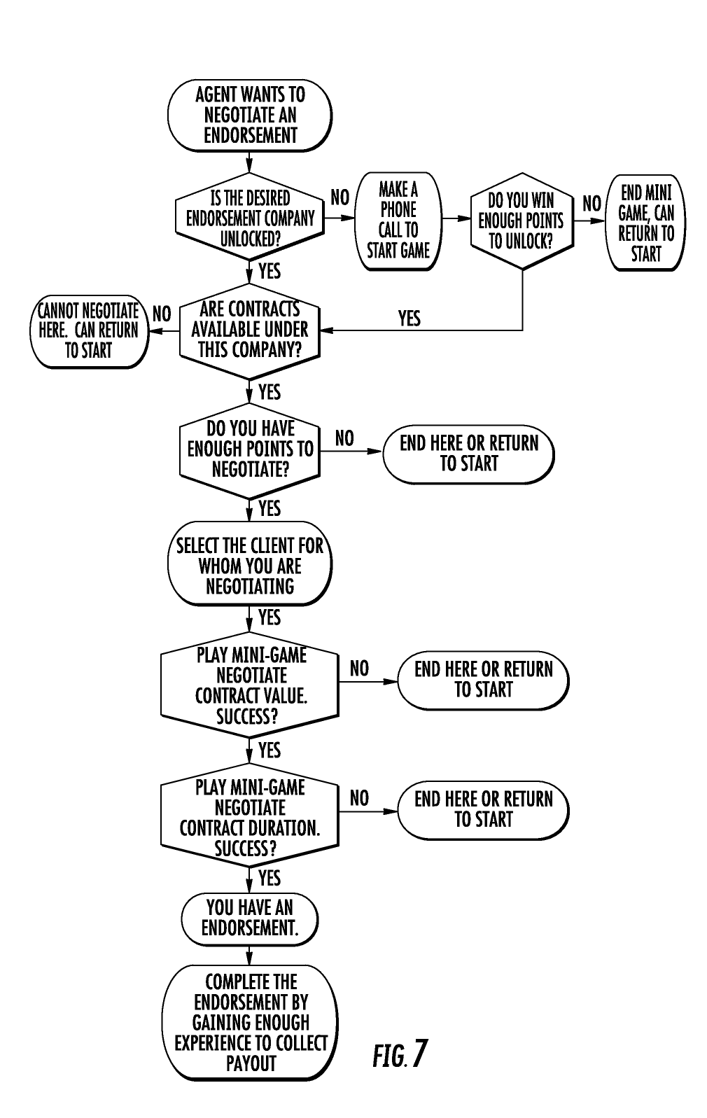

An agent may try to gain an endorsement for a client, e.g., as shown in FIG. 7. Endorsement points are rewarded to the agent as Messages/Agendas are completed and gifts are sent to prospects and clients. These points are determined by the type of item purchased and the value of the item. For example, a chartered jet wins points towards Transportation endorsements.

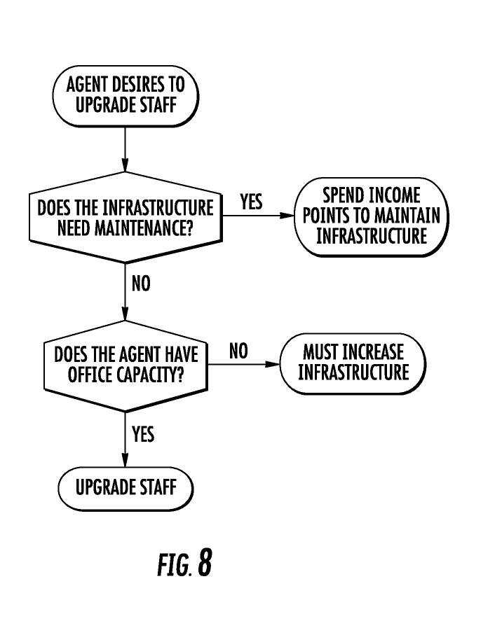

An agent may be required to spend Income Points in order to maintain his current infrastructure. Over time, the buildings and other structures deteriorate and require maintenance. Full capacity is only available when the infrastructure is at an acceptable level of maintenance. An agent may need to add more infrastructure and staff in order to gain new clients, e.g., as shown in FIG. 8. The amount of infrastructure required for a client is dependent upon his Diva Rank. Additionally, endorsements require Capacity since the maintenance of such contracts would require the attention of staff members in real life. At times, a client may request a specific staff member requiring this to be added by the agent. The ability to add staff is dependent on the capacity of the office infrastructure, Income Points available, and Years of Experience. As the agent gains experience, higher level staff members are available to hire. The ability to add office infrastructure is dependent on Income Points available, and Years of Experience. Certain office additions, such as opening a new location in a different city, may require Facebook credits or other currency and not be available for Income Points or Clout.

Embodiments of the present disclosure are contemplated in which users can be provided with opportunities to role-play in many different ways reflective of real life and to simulate the dynamics of building relationships with real-life individuals. In various games a user may play, e.g., a venture capitalist/investor, a persona seeking a date with a real-world person, a mercenary or spy building relationships to perform covert work, etc. Such games could be played by a player alone or as a member of a social group. Many opportunities can be provided for players to interact with, and develop relationships with, simulated real-world individuals as well as with other players in the game.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items. Although the terms first, second, third, etc. may be used herein to describe various elements and components, these elements and components should not be limited by these terms. These terms may be only used to distinguish one element or component from another element or component. Terms such as “first,” “second,” and other numerical terms when used herein do not imply a sequence or order unless clearly indicated by the context. Thus, a first element or component discussed herein could be termed a second element or component without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of providing a game, comprising:
using a computer network, generating a simulated environment in which a user can play the role of a person building a personal relationship with one or more simulated individuals in the simulated environment, the one or more simulated individuals representing one or more real world personalities and/or real world entities;
receiving input from the user via the computer network;
receiving data representing real world facts related to the one or more real world personalities and/or entities; and
determining the user's progress in the game based on the received user input and the received data representing the real world facts.

2. The method of claim 1, further comprising:
simulating traits for the person based on the user input;
simulating traits for the one or more simulated individuals based on data representing real world facts about the one or more real world personalities and/or entities; and
simulating one or more effects of the traits on simulated interactions between the person and one of the simulated individuals.

3. The method of claim 2, further comprising simulating a change in a relationship between the person and the one of the simulated individuals based on the simulated interactions.

4. The method of claim 1, further comprising simulating opportunities for the person to acquire and/or use a plurality of simulated resources to affect a relationship with one of the simulated individuals.

5. The method of claim 4, wherein the simulated resources include material resources.

6. The method of claim 1, wherein the user's progress in the game is determined at least in part by a status of one or more personal relationships between the person and the one or more simulated individuals.

7. The method of claim 1, wherein the data representing real world facts is received in real time and/or near-real time.

8. The method of claim 1, wherein the personal relationship comprises one or more of the following: a business relationship, a dating relationship, a friendship, a romantic relationship, a mercenary relationship, and a professional relationship.

9. The method of claim 1, wherein the user can play the role of one or more of the following: an agent, a date seeker, a mercenary, and a spy.

10. The method of claim 1, wherein the real world facts related to the one or more real world personalities and/or entities include one or more of the following: news coverage, life events, personality traits, income, popularity, reputation, and fame.

11. The method of claim 1, further comprising simulating scenarios in which the person and the one of the simulated individuals may interact based on the data representing real world facts.

12. The method of claim 1, further comprising:
simulating a scenario in which the person and one of the simulated individuals may interact; and
providing an outcome of the scenario in which a relationship between the person and the one of the simulated individuals is changed.

13. A method of providing a game, comprising:
using a computer network, generating a simulated environment in which a user can play the role of an agent for one or more real world personalities and/or real world entities;
receiving input from the user via the computer network;
receiving data representing real world facts related to the one or more real world personalities and/or entities; and
determining the user's progress in the game based on the received user input and the received data representing the real world facts.

14. The method of claim 13, further comprising simulating opportunities for the agent to acquire and/or use a plurality of resources to develop an agent career.

15. The method of claim 14, wherein the resources include experience, income, and/or influence.

16. The method of claim 14, further comprising simulating opportunities for the agent to add infrastructure and/or staff.

17. The method of claim 13, further comprising simulating a plurality of scenarios in which traits of the agent and the real world facts related to the one or more real world personalities and/or entities influence an outcome of interaction between the agent and the one or more real world personalities and/or entities.

18. The method of claim 13, further comprising simulating opportunities in the environment for the agent to make and/or keep the one or more real world personalities and/or entities happy as one or more clients of the agent.

19. The method of claim 18, wherein the opportunities include one or more of the following: to make telephone calls, to give gifts, to fulfill requests, to make deals, to exert influence, to make a pitch, to entertain, and to network.

20. The method of claim 13, further comprising simulating opportunities for interaction between the agent and the one or more real world personalities and/or entities, and configuring the opportunities to lead to one or more of the following, based on user input: (a) the agent's obtaining the one or more real world personalities and/or entities as one or more clients, (b) the agent's not obtaining the one or more real world personalities and/or entities as one or more clients, (c) the agent's keeping the one or more real world personalities and/or entities as one or more clients, and (d) the agent's not keeping the one or more real world personalities and/or entities as one or more clients.

21. The method of claim 13, wherein the one or more real world personalities and/or entities include one more of the following: an athlete, a performer, a politician, an artist, a team, a business, a brand, a group, and an organization.

22. The method of claim 13, wherein the real world facts related to the one or more real world personalities and/or entities include one or more of the following: news reports, life events, personality traits, income, popularity, reputation, and fame.
